(19) United States
(12) Patent Application Publication
(10) Pub. No.: US 2017/0162026 A1
(43) Pub. Date: Jun. 8, 2017

(54) LOCATION IDENTIFICATION PLATFORM

(71) Applicant: Akeem Ojirogbe, Atlanta, GA (US)

(72) Inventor: Akeem Ojirogbe, Atlanta, GA (US)

(21) Appl. No.: 15/366,896

(22) Filed: Dec. 1, 2016

Related U.S. Application Data
(60) Provisional application No. 62/261,945, filed on Dec. 2, 2015.

(51) Int. Cl. G08B 21/18; G08B 5/36

(52) U.S. Cl. CPC G08B 21/18; G08B 5/36

(57) ABSTRACT

A location identification platform may be provided. The platform may comprise, but not be limited to, a panel, a host device, and a guest device. The panel may comprise a display configured to illuminate upon receiving an activation signal, and a computing module configured to receive the activation signal. The host device configured to send the activation signal to the panel upon a determination that received location information is within a predetermined radius. The guest device configured to provide location information to the host device.

### RELATED APPLICATION

Under provisions of 35 U.S.C. §119(e), the Applicant claims the benefit of U.S. provisional application No. 62/261,945, filed Dec. 2, 2015, which is incorporated herein by reference. It is intended that the referenced application may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to identifying a location to, for example, an individual searching for a specific address.

### BACKGROUND

Often, an individual may have trouble finding a specific location. For example, a pizza delivery person or Uber driver may be searching for a specific residential home. However, it can be difficult to determine which building is the specific location. Further, cell phone service may be limited at the residence, especially in the case where the residence comprises a basement. At times, when the individual tries to call the resident at the specific location, the resident may not have cell phone service. This is an unnecessary inconvenience to the resident, and can be problematic if the resident does not have cell phone service.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment for providing a location identification platform;

FIG. 2A illustrates an embodiment of a panel;

FIG. 2B illustrates another embodiment of the panel;

FIG. 3 illustrates schematic of an embodiment integrated with a physical location;

FIG. 4 is a flow chart of a method for providing the location identification platform; and

FIG. 5 is a block diagram of a system including a computing device for performing the method of FIG. 4.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise.

When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of a guest finding a residence, embodiments of the present disclosure are not limited to use only in this context. The context may apply to both commercial and residential premises. Furthermore, although the term “guest” and “host” are used throughout the present disclosure, any user types are considered to be within the scope of the disclosed embodiments.

### I. Platform Overview

Consistent with embodiments of the present disclosure, a location identification platform may be provided. This overview is provided to introduce a selection of concepts in a simplified form that is further described below. This overview is not intended to identify key features or essential features of the claimed subject matter. Nor is this overview intended to be used to limit the claimed subject matter's scope. The location identification platform may be used by individuals or entities to activate a panel when an individual (e.g., a platform user) approaches a desired destination. The activation of the panel may attract the attention of the individual as he or she reaches the destination.

The location identification platform may comprise a panel and may be associated with a physical location. The panel may comprise a computing device connected to a telecommunications network via any conventional means. The panel may further comprise a light or series of lights configured to light up or blink when an individual searching for the location (hereafter, “guest”) approaches.

For example, a host may install the panel at his house. The host may then program the location identification platform with a location (e.g., GPS coordinates for the house, and hereafter, “destination”). The platform may receive GPS coordinates of the guest searching for the location. When the guest is within a specific distance (e.g., one mile) of the destination, the lights may be configured to light up or blink. In this way, the guest searching for the location may be informed that he or she has reached the destination. In some embodiments, the host at the destination may be informed when the guest is soon to arrive.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Platform Configuration

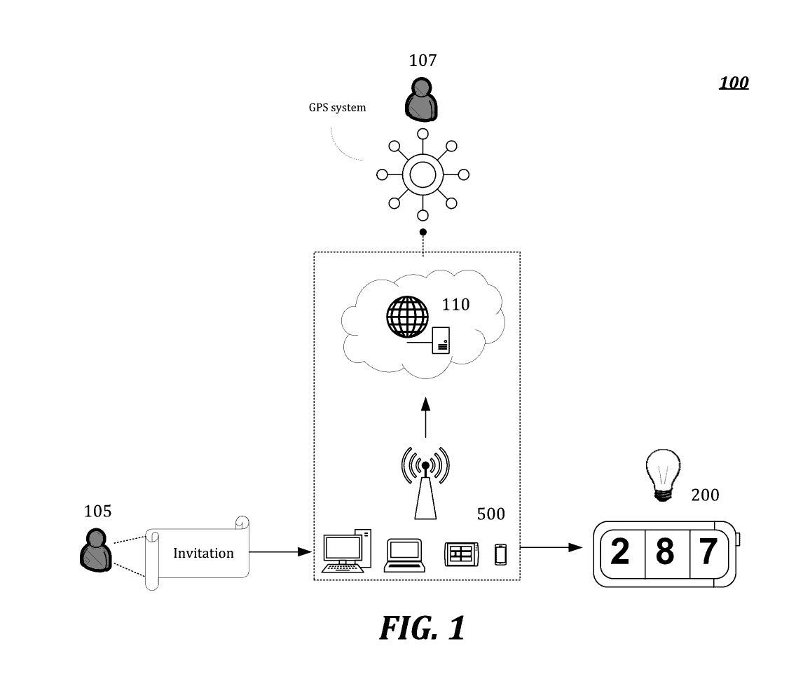

FIG. 1 illustrates one possible operating environment through which a platform consistent with embodiments of the present disclosure may be provided. By way of non-limiting example, a location identification platform 100 may be hosted on a centralized server 110, such as, for example, a cloud computing service. Both a host 105 and a guest 107 may access platform 100 through a software application. The software application may be embodied as, for example, but not be limited to, a website, a web application, a desktop application, and a mobile application compatible with a computing device 500.

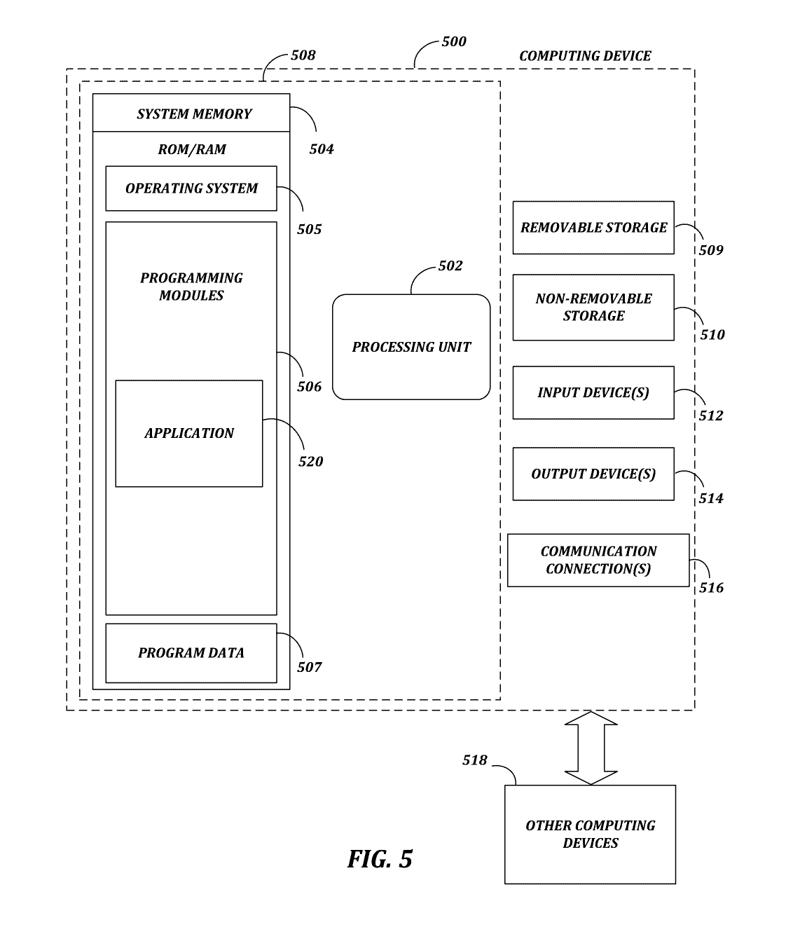

As will be detailed with reference to FIG. 5 below, the computing device through which the platform may be accessed may comprise, but not be limited to, for example, a desktop computer, laptop, a tablet, or mobile telecommunications device. Though the present disclosure is written with reference to a mobile telecommunications device, it should be understood that any computing device may be employed to provide the various embodiments disclosed herein. The computing device may be configured to receive a location, such as, for example, GPS coordinates, of the guest searching for the destination (e.g., the location of a user's residence). The computing device may further be configured to calculate a distance from the guest's location to the destination. The designated location may be associated with an address or GPS coordinates, which may, in some embodiments, be configured at an initiation.

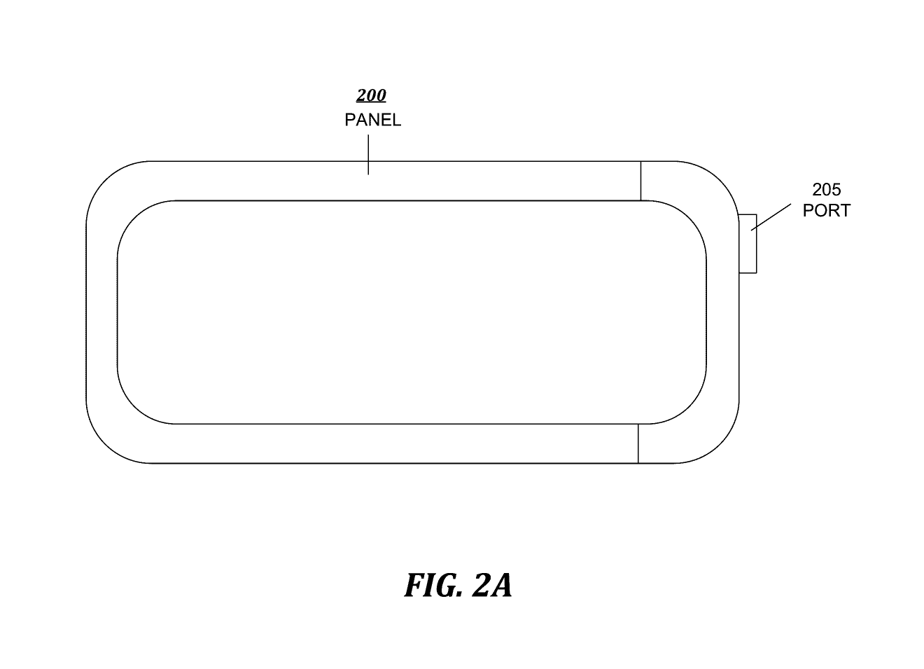

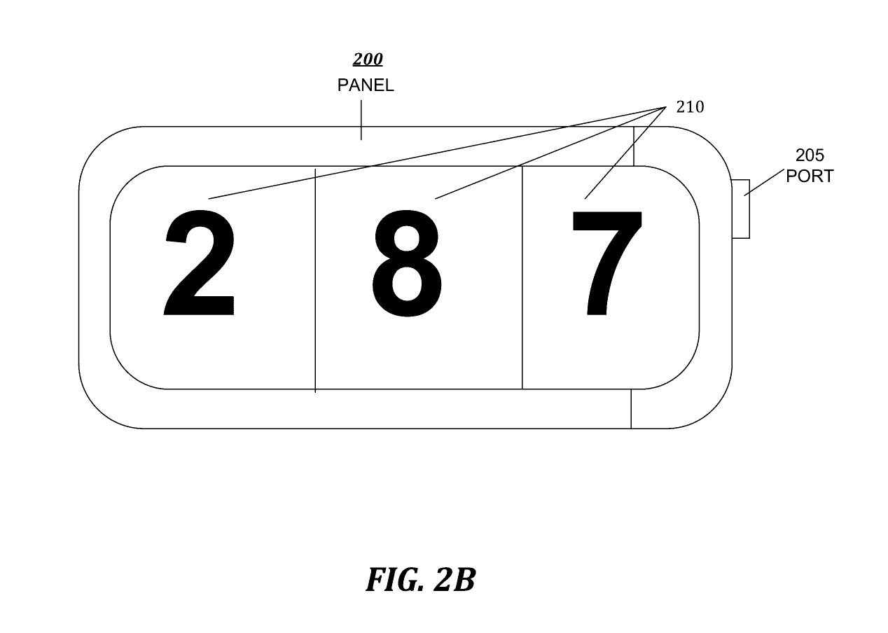

The platform may comprise a panel 200, which may display, in some embodiments, a numerical address. FIG. 2A illustrates a panel 200 comprising a port 205 configured to interface with the platform. Other embodiments may be possible, and FIGS. 2A-2B are used for illustrative purposes.

The port may comprise computing elements (e.g., computing device 500) used to communicate with the host's mobile telecommunications device to receive instructions. The instructions may comprise, but not be limited to, for example, an activation signal or a display message.

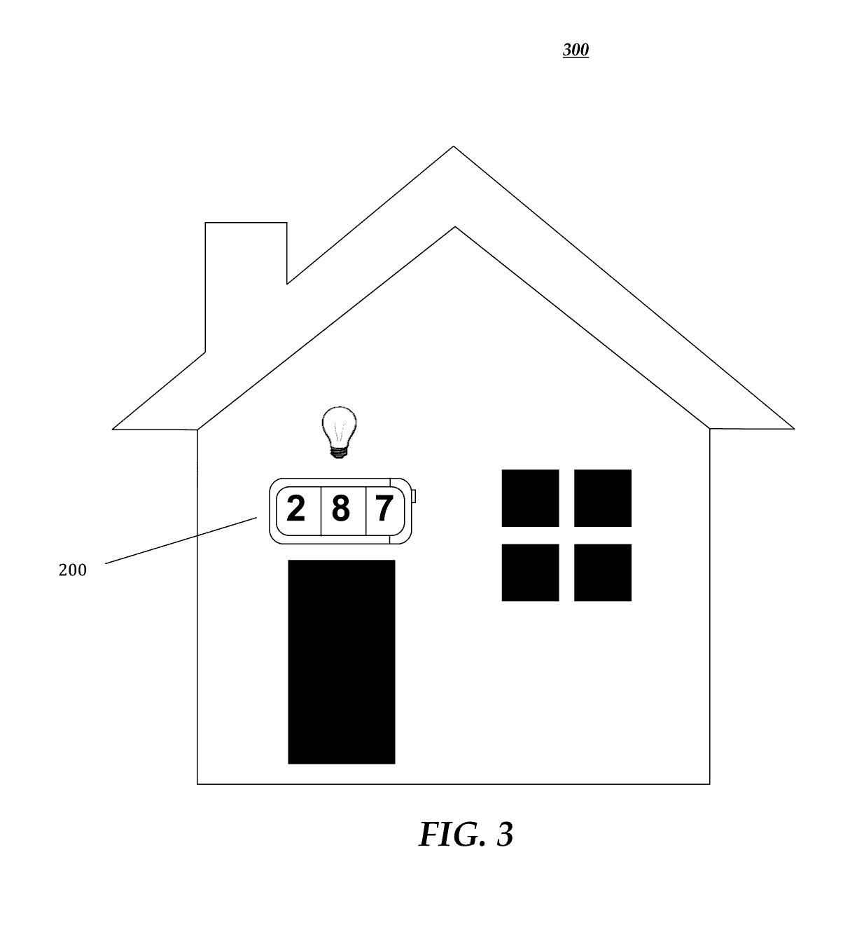

FIG. 2B illustrates the panel 200 comprising numbers 210, which may be used as, but not limited to, a numerical address display. In some embodiments, a textual or graphical message may be displayed on the panel, specific to the guest. FIG. 3 illustrates a schematic of a house 300 comprising a panel 200. Further, the panel may comprise an indicator for identifying the destination. The indicator may comprise one or more lights or LEDs. Further, the indicator may comprise a plurality of colors (e.g., white red, yellow and blue) and/or be configured to flash. Some embodiments may further comprise a solar panel and/or battery for powering the indicator. The indicator may be embodied as a panel with a configurable display. For example, the indicator may be configured to display alphanumeric characters and images. In this way, the indicator may provide a distinct indication of the destination. It should be understood that FIG. 3 only displays one possible location at which the panel may be placed.

In some embodiments, the indicator may be activated when the received location is with a designated radius (e.g., one mile) of the destination. In this way, the destination may be identified to the individual, while not requiring a user to manually activate and deactivate the indicator. The platform may enable the host to define rules for activating the panel (e.g., distances from the guest to the destination), and notify the host when the guest is near.

### III. Platform Operation

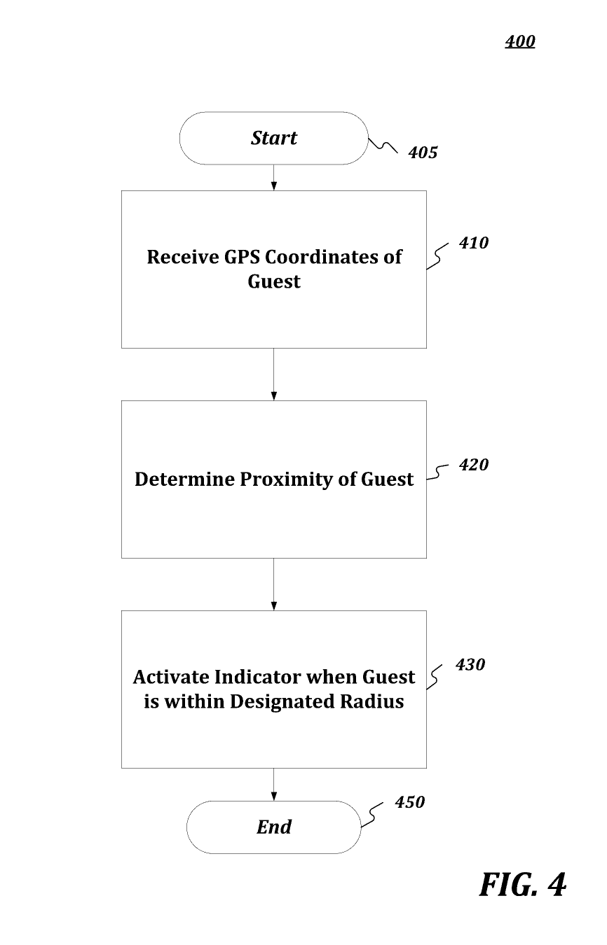

FIG. 4 is a flow chart setting forth the general stages involved in a method 400 consistent with an embodiment of the disclosure for providing location indication platform 100. Method 400 may be implemented using a computing device 500 as described in more detail below with respect to FIG. 5.

Although method 400 has been described to be performed by platform 100, it should be understood that computing device 500 may be used to perform the various stages of method 400. Furthermore, in some embodiments, different operations may be performed by different networked elements in operative communication with computing device 500. For example, server 110 may be employed in the performance of some or all of the stages in method 400. Moreover, server 110 may be configured much like computing device 500.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of method 400 will be described in greater detail below.

Method 400 may begin at starting block 405 and proceed to stage 410 where platform 100 may receive a feed of location coordinates from the guest searching for the destination. In some embodiments, the host may send the guest a request to share location information. The location coordinates may be received, for example, by a GPS device on the guest's person (e.g. smartphone with embedded GPS). In further embodiments, cell tower triangulation, Wi-Fi access, or other location determination methods may be used.

From stage 410, where platform 100 receives location coordinates from the guest, method 400 may advance to stage 420 where platform 100 may determine a proximity of the guest to the destination. For example, platform 100 may comprise a GPS detection device on the panel 200 to determine the destination's location. In further embodiments, the platform may receive a manually-input address or GPS coordinates (e.g., during a start-up initiation) to be used as the destination location. Using the received location coordinates and the destination location, platform may calculate the distance between the destination and the guest.

Once platform 100 determines the proximity of the guest to the destination in stage 420, method 400 may continue to stage 430 where platform 100 may activate an indicator when the guest is with a pre-determined distance of the destination. For example, one or more lights or LEDs may be activated. The indicator may comprise a plurality of colors and may be embodied in a plurality of configurations. The one or more lights or LEDs may be configured to flash or stay solid.

Once platform 100 activates the indicator in stage 430, method 400 may then end at stage 440. The host may be enabled to deactivate the panel via the platform.

### IV. Platform Architecture

The location identification platform 100 may be embodied as, for example, but not be limited to, a website, a web application, a desktop application, and a mobile application compatible with a computing device. The computing device may comprise, but not be limited to, a desktop computer, laptop, a tablet, or mobile telecommunications device. Moreover, the location identification platform 100 may be hosted on a centralized server, such as, for example, a cloud computing service. Although method 400 has been described to be performed by a computing device 500, it should be understood that, in some embodiments, different operations may be performed by different networked elements in operative communication with computing device 500.

Embodiments of the present disclosure may comprise a system having a memory storage and a processing unit. The processing unit may be coupled to the memory storage, wherein the processing unit is configured to perform the stages of method 400.

FIG. 5 is a block diagram of a system including computing device 500. Consistent with an embodiment of the disclosure, the aforementioned memory storage and processing unit may be implemented in a computing device, such as computing device 500 of FIG. 5. Any suitable combination of hardware, software, or firmware may be used to implement the memory storage and processing unit. For example, the memory storage and processing unit may be implemented with computing device 500 or any of other computing devices 518, in combination with computing device 500. The aforementioned system, device, and processors are examples and other systems, devices, and processors may comprise the aforementioned memory storage and processing unit, consistent with embodiments of the disclosure.

With reference to FIG. 5, a system consistent with an embodiment of the disclosure may include a computing device, such as computing device 500. In a basic configuration, computing device 500 may include at least one processing unit 502 and a system memory 504. Depending on the configuration and type of computing device, system memory 504 may comprise, but is not limited to, volatile (e.g. random access memory (RAM)), non-volatile (e.g. read-only memory (ROM)), flash memory, or any combination. System memory 504 may include operating system 505, one or more programming modules 506, and may include a program data 507. Operating system 505, for example, may be suitable for controlling computing device 500′s operation. In one embodiment, programming modules 506 may include proximity determination application 520. Furthermore, embodiments of the disclosure may be practiced in conjunction with a graphics library, other operating systems, or any other application program and is not limited to any particular application or system. This basic configuration is illustrated in FIG. 5 by those components within a dashed line 508.

Computing device 500 may have additional features or functionality. For example, computing device 500 may also include additional data storage devices (removable and/or non-removable) such as, for example, magnetic disks, optical disks, or tape. Such additional storage is illustrated in FIG. 5 by a removable storage 509 and a non-removable storage 510. Computer storage media may include volatile and nonvolatile, removable and non-removable media implemented in any method or technology for storage of information, such as computer readable instructions, data structures, program modules, or other data. System memory 504, removable storage 509, and non-removable storage 510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 500. Any such computer storage media may be part of device 500. Computing device 500 may also have input device(s) 512 such as a keyboard, a mouse, a pen, a sound input device, a touch input device, etc. Output device(s) 514 such as a display, speakers, a printer, etc. may also be included. The aforementioned devices are examples and others may be used.

Computing device 500 may also contain a communication connection 516 that may allow device 500 to communicate with other computing devices 518, such as over a network in a distributed computing environment, for example, an intranet or the Internet. Communication connection 516 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 504, including operating system 505. While executing on processing unit 502, programming modules 506 (e.g., proximity determination application 520) may perform processes including, for example, one or more of method 400′s stages as described above. The aforementioned process is an example, and processing unit 502 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

### V. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

1. A method comprising:
determining a guest's location;
calculating the guest's proximity to a location; and
activating a panel physically located within the location when the guest's proximity is within a predefined radius, the panel's activation being configured to attract the guest's attention to the location.

2. The method of claim 1, further comprising, sending, from the host to the guest, a request to track the guest's location.

3. The method of claim 1, wherein activating the panel comprises sending a signal to the panel via a telecommunications module associated with a host device.

4. The method of claim 3, wherein activating the panel comprises causing the panel to light up.

5. The method of claim 3, wherein activating the panel comprises causing the panel to blink.

6. The method of claim 3, wherein activating the panel comprises causing the panel to illuminate an address.

7. The method of claim 3, wherein activating the panel comprises causing the panel to illuminate at least one of the following: a graphic and a text.

8. The method of claim 1, further comprising notifying a host that the guest is within the predefined radius.

9. An apparatus comprising:
an indicator configured to illuminate upon receiving an activation signal; and
a computing module configured to receive the activation signal,
wherein the computing module is in remote communication with a host device,
wherein the host device is configured to provide the activation signal when a guest device is within a predefined radius to a destination, and
wherein the apparatus is physically located within a premise of the destination.

10. The apparatus of claim 9, wherein the indicator is an alphanumeric display.

11. The apparatus of claim 10, wherein the display is configured to blink.

12. A system comprising:
a panel comprising:
an indicator configured to illuminate upon receiving an activation signal, and
a computing module configured to receive the activation signal;
a host device configured to send the activation signal to the panel upon a determination that received location information is within a predetermined radius; and
a guest device configured to provide location information to the host device.

13. The apparatus of claim 9, wherein the display is an alphanumeric display.

14. The apparatus of claim 9, wherein the display is configured to blink.
